(19) United States
(12) Patent Application Publication
(10) Pub. No.: US 2018/0300764 A1
(43) Pub. Date: Oct. 18, 2018

(54) MODELING CUSTOMER ACQUISITION PROPENSITIES FOR EDUCATIONAL TECHNOLOGY PRODUCTS

(71) Applicant: LinkedIn Corporation, Sunnyvale, CA (US)

(72) Inventors: Sandeep Rohilla, Belmont, CA (US); Zhaoying Han, Mountain View, CA (US); Aayush S. Mahendru, Santa Clara, CA (US)

(73) Assignee: LinkedIn Corporation, Sunnyvale, CA (US)

(21) Appl. No.: 15/487,316

(22) Filed: Apr. 13, 2017

(51) Int. Cl. G06Q 30/02; G06N 5/04

(52) U.S. Cl. CPC G06Q 30/0269; G06Q 50/01; G06Q 30/0277; G06N 5/04

(57) ABSTRACT

The disclosed embodiments provide a system for processing data. During operation, the system obtains a set of features associated with a customer, wherein the set of features includes profile data from an online professional network. Next, the system uses a statistical model and the features to predict a likelihood of acquiring the customer for an educational technology product. The system then uses the likelihood to generate output for use in targeting the customer with the educational technology product.

### RELATED APPLICATION

The subject matter of this application is related to the subject matter in a co-pending non-provisional application by inventors Ming M. Ng, Zhaoying Han, Sandeep Rohilla, Coleman Patrick King III and Tony Yin, entitled “Automatically Prioritizing Sales Leads for Educational Technology Products,” having Ser. No. 15/478,029, and filing date 3 Apr. 2017 (Attorney Docket No. LI-P2266.LNK.US).

### BACKGROUND

### Field

The disclosed embodiments relate to techniques for managing sales and marketing activities. More specifically, the disclosed embodiments relate to techniques for modeling customer acquisition propensities for educational technology products.

### Related Art

Social networks may include nodes representing entities such as individuals and/or organizations, along with links between pairs of nodes that represent different types and/or levels of social familiarity between the nodes. For example, two nodes in a social network may be connected as friends, acquaintances, family members, and/or professional contacts. Social networks may further be tracked and/or maintained on web-based social networking services, such as online professional networks that allow the entities to establish and maintain professional connections, list work and community experience, endorse and/or recommend one another, run advertising and marketing campaigns, promote products and/or services, and/or search and apply for jobs.

In turn, social networks and/or online professional networks may facilitate sales and marketing activities and operations by the entities within the networks. For example, sales professionals may use an online professional network to identify prospective customers, maintain professional images, establish and maintain relationships, and/or close sales deals. Moreover, the sales professionals may produce higher customer retention, revenue, and/or sales growth by leveraging social networking features during sales activities. For example, a sales representative may improve customer retention by tailoring his/her interaction with a customer to the customer's behavior, priorities, needs, and/or market segment, as identified based on the customer's activity and profile on an online professional network.

Consequently, the performance of sales professionals may be improved by using social network data to develop and implement sales strategies.

### BRIEF DESCRIPTION OF THE FIGURES

FIG. 1 shows a schematic of a system in accordance with the disclosed embodiments.

FIG. 2 shows a system for processing data in accordance with the disclosed embodiments.

FIG. 3 shows a flowchart illustrating the processing of data in accordance with the disclosed embodiments.

FIG. 4 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

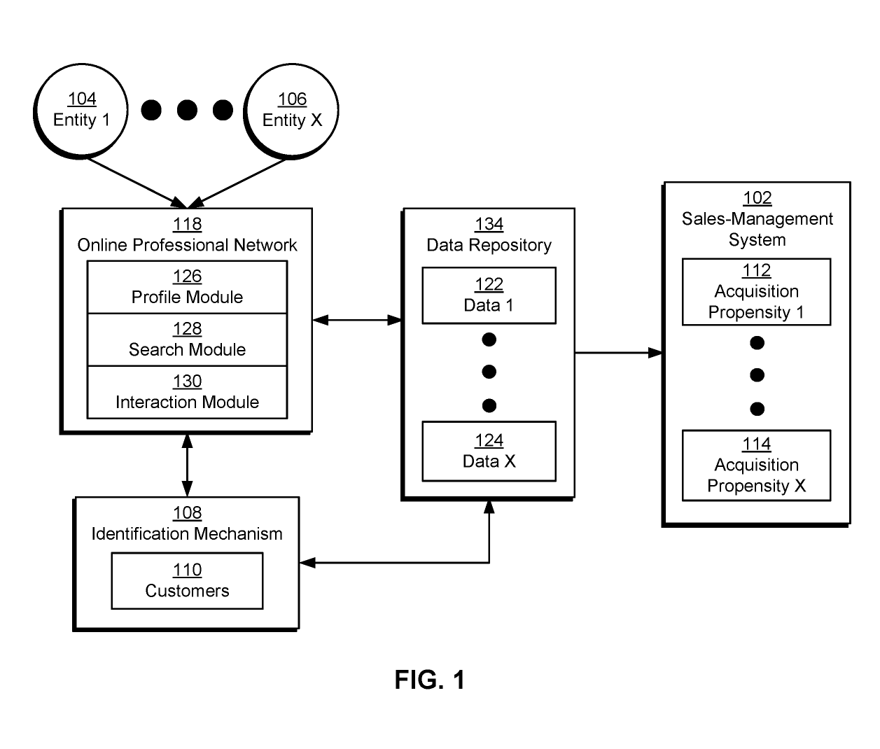

The disclosed embodiments provide a method, apparatus, and system for processing data. More specifically, the disclosed embodiments provide a method, apparatus, and system for modeling customer acquisition propensities for educational technology products. As shown in FIG. 1, customers 110 may be members of a social network, such as an online professional network 118 or other community of users that allows a set of entities (e.g., entity 1 104, entity x 106) to interact with one another in a professional and/or business context.

The entities may include users that use online professional network 118 to establish and maintain professional connections, list work and community experience, endorse and/or recommend one another, and/or search and apply for jobs. The entities may also include companies, employers, and/or recruiters that use the online professional network to list jobs, search for potential candidates, and/or provide business-related updates to users.

The entities may use a profile module 126 in online professional network 118 to create and edit profiles containing profile pictures, along with information related to the entities' professional and/or industry backgrounds, experiences, summaries, projects, and/or skills. The profile module may also allow the entities to view the profiles of other entities in the online professional network.

Next, the entities may use a search module 128 to search online professional network 118 for people, companies, jobs, and/or other job- or business-related information. For example, the entities may input one or more keywords into a search bar to find profiles, job postings, articles, and/or other information that includes and/or otherwise matches the keyword(s). The entities may additionally use an “Advanced Search” feature on the online professional network to search for profiles, jobs, and/or information by categories such as first name, last name, title, company, school, location, interests, relationship, industry, groups, salary, and/or experience level.

The entities may also use an interaction module 130 to interact with other entities on online professional network 118. For example, the interaction module may allow an entity to add other entities as connections, follow other entities, send and receive messages with other entities, join groups, and/or interact with (e.g., create, share, re-share, like, and/or comment on) posts from other entities. The interaction module may also allow the entity to upload and/or link an address book or contact list to facilitate connections, follows, messaging, and/or other types of interactions with the entity's external contacts.

Those skilled in the art will appreciate that online professional network 118 may include other components and/or modules. For example, the online professional network may include a homepage, landing page, and/or newsfeed that provides the entities with the latest postings, articles, and/or updates from the entities' connections and/or groups. Similarly, the online professional network may include mechanisms for recommending connections, job postings, articles, and/or groups to the entities.

In one or more embodiments, data (e.g., data 1 122, data x 124) related to the entities' profiles and activities on online professional network 118 is aggregated into a data repository 134 for subsequent retrieval and use. For example, each profile update, profile view, connection, follow, post, comment, like, share, search, click, message, interaction with a group, and/or other action performed by an entity in the online professional network may be tracked and stored in a database, data warehouse, cloud storage, and/or other data-storage mechanism providing data repository 134.

The entities may also include a set of customers 110 that purchase products through online professional network 118. For example, the customers may include individuals and/or organizations with profiles on the online professional network and/or sales accounts with sales professionals that operate through the online professional network. As a result, the customers may use the online professional network to interact with professional connections, list and apply for jobs, establish professional brands, purchase or use products offered through the online professional network, and/or conduct other activities in a professional and/or business context.

Customers 110 may also be targeted for marketing or sales activities by other entities in online professional network 118. For example, the customers may be companies that purchase business products and/or solutions that are offered by the online professional network to achieve goals related to hiring, marketing, advertising, and/or selling. In another example, the customers may be individuals and/or companies that are targeted by marketing and/or sales professionals through the online professional network.

As shown in FIG. 1, customers 110 may be identified by an identification mechanism 108 using data from data repository 134 and/or online professional network 118. For example, identification mechanism 108 may identify the customers by matching profile data, group memberships, industries, skills, customer relationship data, and/or other data for the customers to keywords related to products that may be of interest to the customers. Identification mechanism 108 may also identify the customers as individuals and/or companies that have sales accounts with the online professional network and/or products offered by or through the online professional network. As a result, the customers may include entities that have purchased products through and/or within the online professional network, as well as entities that have not yet purchased but may be interested in products offered through and/or within the online professional network.

Identification mechanism 108 may also match customers 110 to products using different sets of criteria. For example, the identification mechanism may match customers in recruiting roles to recruiting solutions, customers in sales roles to sales solutions, customers in marketing roles to marketing solutions, customers in learning and development roles to educational technology products, and customers in advertising roles to advertising solutions. If different variations of a solution are available, the identification mechanism may also identify the variation that may be most relevant to the customer based on the size, location, industry, and/or other attributes of the customer. In another example, products offered by other entities through online professional network 118 may be matched to current and/or prospective customers through criteria specified by the other entities. In a third example, the customers may include all entities in the online professional network, which may be targeted with products such as “premium” subscriptions or memberships with the online professional network.

After customers 110 are identified, they may be targeted with relevant products offered by or through online professional network 118. For example, marketing and/or sales professionals may use newsletters, emails, phone calls, and/or other types of communications to engage the customers with recruiting, marketing, sales, and/or advertising solutions that may be of interest to the customers. After a sales deal is closed with a given customer, a sales professional may follow up with the customer to improve the customer lifetime value (CLV) and retention of the customer.

To facilitate prioritization of marketing and/or sales activities with customers 110, a sales-management system 102 may determine an acquisition propensity (e.g., acquisition propensity 1 112, acquisition propensity x 114) for each customer. The acquisition propensity may represent the likelihood of acquiring the customer with respect to an educational technology product (e.g., e-learning product) and/or other type of product offered by or within online professional network 118. The acquisition propensity may also, or instead, refer to the customer's likelihood of “acquiring” a subscription or other purchase associated with the educational technology product. As described in further detail below, the sales-management system may use profile data from the online professional network and/or other features associated with the customer to estimate the acquisition propensity for the customer. The sales-management system may then use the estimated acquisition propensity and/or a market segment of the customer to generate output for targeting the customer with the educational technology product, thereby improving acquisition of customers of the educational technology product.

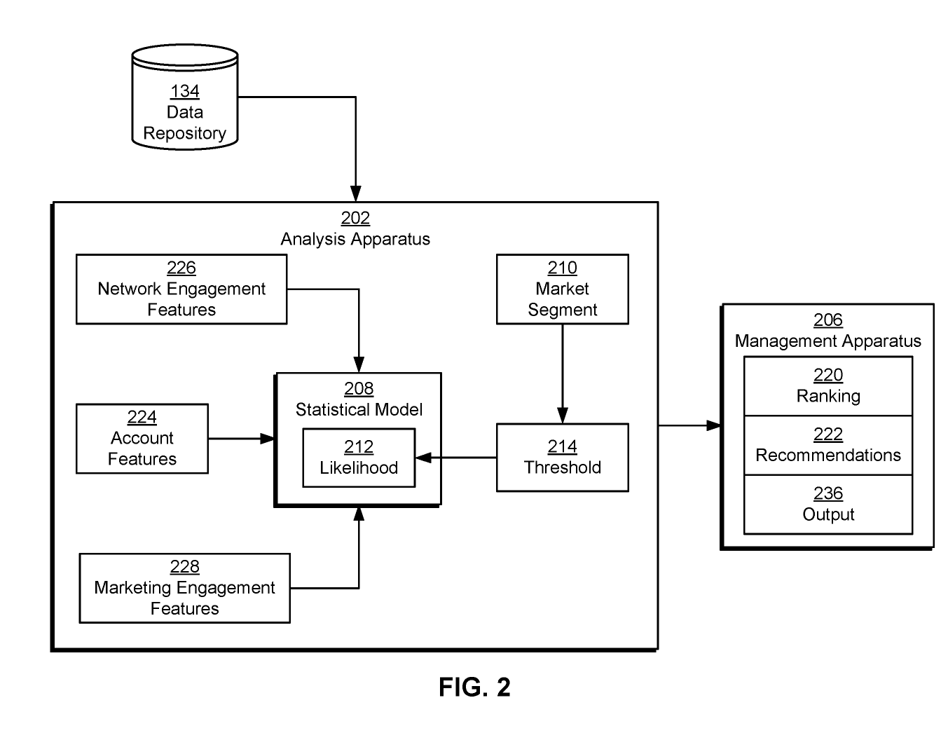

FIG. 2 shows a system for processing data in accordance with the disclosed embodiments. More specifically, FIG. 2 shows a system for evaluating acquisition propensities for a set of customers of an educational technology product, such as sales-management system 102 of FIG. 1. As shown in FIG. 2, the system includes an analysis apparatus 202 and a management apparatus 206. Each of these components is described in further detail below.

Analysis apparatus 202 may estimate, for each customer or prospective customer of the educational technology product, a likelihood 212 of acquiring the customer for the educational technology product. For example, likelihood 212 may be a score and/or probability that the customer will activate a free trial of the educational technology product, purchase the educational technology product, participate in another promotional offer related to the educational technology product, and/or otherwise engage in customer acquisition activity with the educational technology product.

As described above, the customer may be a prospective customer that is identified using data from data repository 134. Analysis apparatus 202 may also use data from data repository 134 to generate a set of features for the customer, including one or more account features 224, network engagement features 226, and/or marketing engagement features 228. For example, analysis apparatus 202 may use one or more queries to obtain the features directly from data repository 134, extract one or more features from the queried data, and/or aggregate the queried data into one or more features.

Account features 224 may characterize the customer's sales-related behavior with respect to the educational technology product and/or other products (e.g., marketing solutions, sales solutions, talent solutions, etc.) offered through the online professional network. First, the account features may include a potential spending that represents the maximum future spending of the customer with the product, independent of the customer's likelihood of purchasing the product. The potential spending may represent a dollar amount spent by the customer over a given period (e.g., one year, three years, customer lifetime) and/or the number of licenses the customer will purchase over the period. The potential spending may be calculated by applying a statistical model to features related to the demographics of the customer and/or a company at which the customer is employed, the relevance of the customer's activities to the product, and/or the relevance of the culture at the company to the product.

Second, account features 224 may include a lead score representing the quality or qualification of the customer as a sales lead for one or more products (e.g., marketing solution, sales solution, educational technology product, etc.). For example, the lead score may represent the propensity of the customer in engaging with an upsell and/or regular sales opportunity with a given product. The lead score may be produced by using features that are relevant to the product to calculate a set of quality indicators that represent different components of the quality or qualification of the sales lead, and then aggregating and normalizing the quality indicators into a numeric score. Calculating lead scores for potential sales leads is further described in a co-pending non-provisional application by inventors Ming M. Ng, Zhaoying Han, Sandeep Rohilla, Coleman Patrick King III and Tony Yan, entitled “Automatically Prioritizing Sales Leads for Educational Technology Products,” having Ser. No. 15/478,029, and filing date 3 Apr. 2017 (Attorney Docket No. LI-P2266.LNK.US), which is incorporated herein by reference.

Account features 224 may additionally include a percentile associated with the lead score. For example, the account features may specify, for each lead score included in the account features, the percentile representing the lead score in a distribution of lead scores for the corresponding product.

Network engagement features 226 may represent the customer's level of engagement with and/or presence on the online professional network. For example, the network engagement features may track, for all emails or other electronic communications sent to the user from the online professional network, the number of emails opened and/or links clicked within the emails by the user over a pre-specified period and/or all time. In another example, the engagement features may track the customer's page views of specific pages or types of pages in the online professional network, such as pages that do not pertain to primary features (e.g., profile pages, search pages, content feed, etc.) of the online professional network. In a third example, the network engagement features may identify the customer's level of engagement with content (e.g., articles, posts, etc.) displayed within the online professional network. In a fourth example, the network engagement features may specify the length of time the customer has been a member of the online professional network and/or the number of connection recommendations the user has within a “People You May Know” feature of the online professional network. In a fifth example, the network engagement features may include the number of members in the customer's second-degree network that have “premium” subscriptions or memberships with the online professional network. In a sixth example, the network engagement features may identify the recency of the customer's latest profile update as the number of days since the customer last updated his/her profile in the online professional network.

Marketing engagement features 228 may represent the customer's level of engagement with marketing materials associated with products offered through the online professional network. For example, the marketing engagement features may track the customer's click-through rate (CTR) for all marketing emails from the online professional network over one or more periods (e.g., the last 30, 60, 90, and/or 180 days). The marketing engagement features may also, or instead, characterize the customers' level of engagement with other types of marketing (e.g., online, phone, newsletter, etc.).

After account features 224, network engagement features 226, and marketing engagement features 228 are obtained from data repository 134, analysis apparatus 202 may modify some or all of the features. First, the analysis apparatus may apply imputations that add default values, such as zero numeric values or median values, to features with missing values. Second, the analysis apparatus may “bucketize” numeric values for some features (e.g., number of employees) into ranges of values and/or a smaller set of possible values. Third, the analysis apparatus may apply, to one or more subsets of features, a log transformation that reduces skew in numeric values and/or a binary transformation that converts zero and positive numeric values to respective Boolean values of zero and one. Fourth, the analysis apparatus may normalize scores to be within a range (e.g., between 0 and 10), verify that feature ratios are within the range of 0 and 1, and perform other transformations of the features. In general, such preprocessing and/or modification of features by the analysis apparatus may be performed and/or adapted based on configuration files and/or a central feature list.

Next, analysis apparatus 202 may use account features 224, network engagement features 226, and marketing engagement features 228 as training data for creating a statistical model 208. For example, the analysis apparatus may use a different set of features for each customer to train statistical model 208. The analysis may also obtain, as target output for training the statistical model, the result of a marketing campaign (e.g., email marketing, phone marketing, etc.) with the customer as an activation or non-activation of a free trial or subscription with the educational technology product by the customer.

After statistical model 208 is created, analysis apparatus 202 may apply the statistical model to account features 224, network engagement features 226, and marketing engagement features 228 to calculate likelihood 212 for each new or potential customer of the educational technology product. For example, statistical model 208 may be a regression model and/or another type of propensity model that identifies the customer's propensity in activating a free trial of the educational technology product, purchasing the educational technology product, accepting another promotional offer for the educational technology product, and/or otherwise engaging in acquisition activity with the educational technology product.

Analysis apparatus 202 may also obtain a market segment 210 for the customer. The market segment may represent a type of user or role that is relevant or related to educational content, tools, or features provided with the educational technology product. For example, the market segment may relate to information technology (IT) professionals, software developers, data scientists, recruiters, talent professionals, creative roles (e.g., designers, artistic directors, artists, etc.), managers, and/or decision makers.

Members in a given market segment 210 may be identified using attributes related to job titles, industries, profile attributes, and/or activity related to the market segment. For example, recruiters may be identified by attributes related to employment at a staffing company, high levels of job-posting activity, and/or job titles or other profile attributes with keywords related to recruiting. In another example, talent professionals may be defined as members with job titles and/or other profile attributes related to recruiting, hiring, sourcing, human resources, staffing, and/or other activity related to hiring talent for a company. In a third example, decision makers may include members with high levels of seniority and/or job titles such as “vice president,” “director,” “executive,” and/or “owner.”

Next, analysis apparatus 202 may apply a threshold 214 associated with market segment 210 to likelihood 212. The threshold may represent a minimum value of likelihood 212 required to engage in targeting of customers in the market segment with a given type of marketing campaign (e.g., email, online, newsletter, phone, referral, etc.). For example, the threshold may represent a given percentile in the distribution of values of the likelihood and/or a value that is higher than the likelihood for a pre-specified number or proportion of customers in the market segment. As a result, the threshold may be calculated after values of the likelihood have been determined for all members in the market segment. Alternatively, the threshold may be calculated using historic values of the likelihood for customers of the educational technology product.

After values of likelihood 212 are generated for the customers, management apparatus 206 may use the values to manage sales and/or marketing activity with the customers. First, the management apparatus may generate a ranking 220 of the customers by the likelihood. For example, the management apparatus may rank the customers in descending order of likelihood of acquisition for the educational technology product. The management apparatus may also display the ranking in a user interface; export the ranking to a file, database, and/or other format; and/or enable filtering of the ranking by industry, company, location, market segment 210, and/or other attributes of the customers.

Management apparatus 206 may also generate a set of recommendations 222 associated with the customers. For example, management apparatus 206 may recommend targeting of the customers with different acquisition channels and/or sales strategies based on ranking 220. In turn, the recommendations may be used to match acquisition channels and/or sales strategies that require significant resources (e.g., interaction with sales or marketing professionals) to customers with higher likelihood of acquisition and acquisition channels and/or sales strategies that involve fewer resources (e.g., emails, online marketing or sales, etc.) to customers with lower likelihood of acquisition.

Management apparatus 206 may further generate output 236 for targeting the customers with the educational technology product based on ranking 220 and/or recommendations 222. For example, the management apparatus may transmit a weekly marketing email for the educational technology product to customers with values of likelihood 212 that exceed threshold 214. The management apparatus may also include courses or content in the educational technology product that is relevant to each market segment 210 in an email to the market segment and/or otherwise tailor the email to the market segment. The management apparatus may further track the customer's response to the email as an activation or non-activation of a free trial or subscription with the educational technology product and store the response in data repository 134. In turn, the management apparatus and/or analysis apparatus 202 may use the response and features associated with the customer as additional training data for statistical model 208, thereby improving the performance of the statistical model over time. Consequently, the system of FIG. 2 may improve marketing or sales of products through the online professional network by identifying and targeting customers with higher likelihood of acquisition with the products.

Those skilled in the art will appreciate that the system of FIG. 2 may be implemented in a variety of ways. First, analysis apparatus 202, management apparatus 206, and/or data repository 134 may be provided by a single physical machine, multiple computer systems, one or more virtual machines, a grid, one or more databases, one or more filesystems, and/or a cloud computing system. Analysis apparatus 202 and management apparatus 206 may additionally be implemented together and/or separately by one or more hardware and/or software components and/or layers.

Second, account features 224, network engagement features 226, marketing engagement features 228, and/or other data used to produce likelihood 212 may be obtained from a number of data sources. For example, data repository 134 may include data from a cloud-based data source such as a Hadoop Distributed File System (HDFS) that provides regular (e.g., hourly) updates to data associated with connections, activity with the online professional network, and/or activity with marketing material. Data repository 134 may also include data from an offline data source such as a Structured Query Language (SQL) database, which refreshes at a lower rate (e.g., daily) and provides data associated with profile content (e.g., profile pictures, summaries, education and work history), profile completeness, and/or estimates of potential spending or other metrics from surveys, polls, or other types of feedback.

Finally, statistical model 208 may be implemented using different techniques and/or used to produce values of likelihood 212 in different ways. For example, statistical model 208 may be implemented using artificial neural networks, Bayesian networks, support vector machines, clustering techniques, regression models, random forests, and/or other types of machine learning techniques. In another example, different versions of statistical model 208 may be tailored to different types of products offered by or through the online professional network by creating the versions using different sets of features that are relevant to the products.

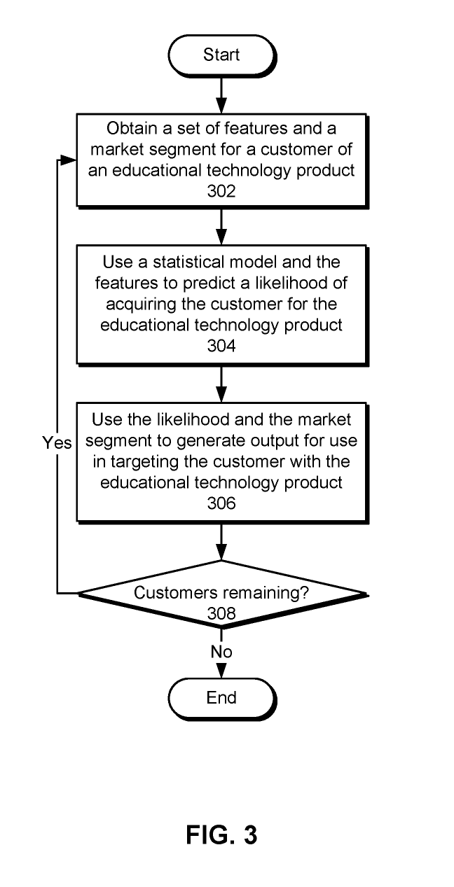

FIG. 3 shows a flowchart illustrating the processing of data in accordance with the disclosed embodiments. More specifically, FIG. 3 shows a flowchart of determining customer acquisition propensities for an educational technology product. In one or more embodiments, one or more of the steps may be omitted, repeated, and/or performed in a different order. Accordingly, the specific arrangement of steps shown in FIG. 3 should not be construed as limiting the scope of the embodiments.

Initially, a set of features and a market segment are obtained for a customer of the educational technology product (operation 302). The market segment may represent information technology (IT) professionals, software developers, data scientists, recruiters, talent professionals, creative roles, managers, decision makers, and/or other types of users to which the educational technology may be interesting or relevant.

The features may include account features, network engagement features, and marketing engagement features. The account features may include a potential spending and/or a metric representing a quality of the customer as a sales lead, such as a lead score and/or percentile associated with the lead score. The potential spending and/or metric may be specified for the educational technology product and/or other products offered through an online professional network. The network engagement features may include a measure of engagement with content in an online professional network, a measure of engagement with emails from the online professional network, a number of premium subscribers in a second-degree network of the customer, a number of recommended connections in a “People You May Know” feature, a recency of a profile update, and/or a page view metric (e.g., number of page views for a given page or type of pages by the customer). As a result, one or more network engagement features may be obtained from profile data for the customer from the online professional network. The marketing engagement features may include a CTR for marketing emails over one or more pre-specified periods.

Next, a statistical model and the features are used to predicate a likelihood of acquiring the customer for the educational technology product (operation 304). For example, the statistical model may estimate the customer's propensity in purchasing the educational technology product, activating a free trial of the educational technology product, and/or participating in another promotional offer for the educational technology product.

Finally, the likelihood and market segment are used to generate output for use in targeting the customer with the educational technology product (operation 306). For example, a threshold for the market segment may be applied to the likelihood. The threshold may represent a percentile (e.g., 20^{th} percentile) associated with the distribution of values of the likelihood and/or a value that represents a pre-specified number of the lowest values for the likelihood (e.g., the lowest 20,000 values of the likelihood). The threshold may be calculated after the likelihood is determined for a pre-specified number of customers in the market segment and/or based on historic values of the likelihood for the market segment.

In turn, the customer may be targeted with a marketing email and/or other type of marketing communication if the customer's likelihood of acquisition is above the threshold. The marketing email may also be tailored to the market segment of the customer. For example, the marketing email may include courses, other content, and/or features in the educational technology product that are relevant to the market segment. Conversely, targeting of the customer may be performed using a cheaper acquisition channel and/or omitted if the customer's likelihood of acquisition does not exceed the threshold. Operations 302-306 may be repeated for remaining customers (operation 308) of the educational technology product, which may include prospective customers in key market segments related to the educational technology product.

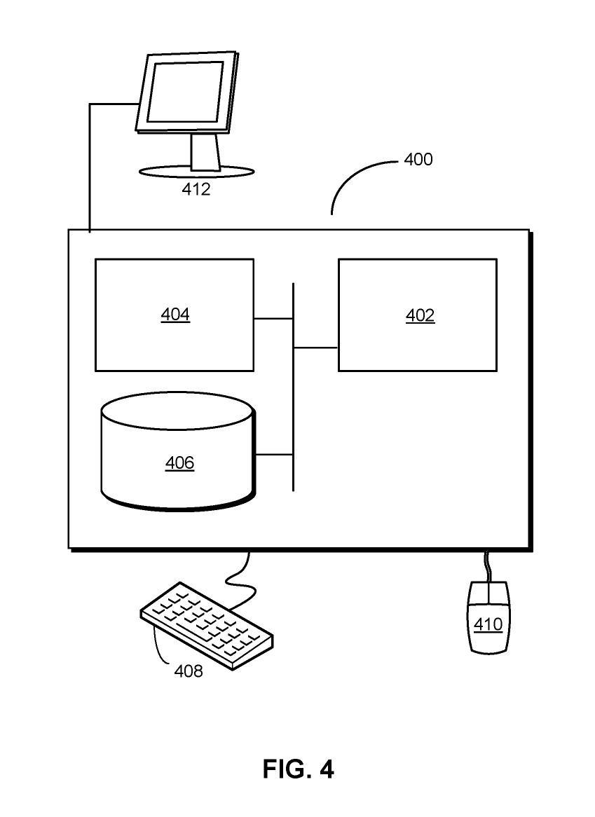

FIG. 4 shows a computer system 400 in accordance with the disclosed embodiments. Computer system 400 includes a processor 402, memory 404, storage 406, and/or other components found in electronic computing devices. Processor 402 may support parallel processing and/or multi-threaded operation with other processors in computer system 400. Computer system 400 may also include input/output (I/O) devices such as a keyboard 408, a mouse 410, and a display 412.

Computer system 400 may include functionality to execute various components of the present embodiments. In particular, computer system 400 may include an operating system (not shown) that coordinates the use of hardware and software resources on computer system 400, as well as one or more applications that perform specialized tasks for the user. To perform tasks for the user, applications may obtain the use of hardware resources on computer system 400 from the operating system, as well as interact with the user through a hardware and/or software framework provided by the operating system.

In one or more embodiments, computer system 400 provides a system for processing data. The system may include an analysis apparatus and a management apparatus, one or both of which may alternatively be termed or implemented as a module, mechanism, or other type of system component. The analysis apparatus may obtain a set of features associated with a customer, including profile data for the customer from an online professional network. Next, the analysis apparatus may use a statistical model and the features to predict a likelihood of acquiring the customer for an educational technology product. The management apparatus may then use the likelihood to generate output for use in targeting the customer with the educational technology product.

In addition, one or more components of computer system 400 may be remotely located and connected to the other components over a network. Portions of the present embodiments (e.g., analysis apparatus, management apparatus, data repository, etc.) may also be located on different nodes of a distributed system that implements the embodiments. For example, the present embodiments may be implemented using a cloud computing system that evaluates acquisition propensities for a set of remote customers of an educational technology product.

By configuring privacy controls or settings as they desire, members of a social network, a professional network, or other user community that may use or interact with embodiments described herein can control or restrict the information that is collected from them, the information s provided to them, their interactions with such information and with other members, and/or how such information is used. Implementation of these embodiments is not intended to supersede or interfere with the members' privacy settings.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
obtaining a set of features associated with a customer, wherein the set of features comprises profile data from an online professional network;
using a statistical model and the features to predict, by one or more computer systems, a likelihood of acquiring the customer for an educational technology product; and
using the likelihood to generate, by the one or more computer systems, output for use in targeting the customer with the educational technology product.

2. The method of claim 1, further comprising:
obtaining a market segment for the customer; and
modifying the output based on the market segment.

3. The method of claim 2, wherein modifying the output based on the market segment comprises:
applying a threshold for the market segment to the likelihood prior to generating the output.

4. The method of claim 2, wherein modifying the output based on the market segment comprises:
tailoring the output to the market segment.

5. The method of claim 1, wherein the set of features comprises:
one or more network engagement features;
one or more marketing engagement features; and
one or more account features.

6. The method of claim 5, wherein the one or more network engagement features include at least one of:
a measure of engagement with content in the online professional network;
a measure of engagement with electronic communications from the online professional network;
a number of premium subscribers in a second-degree network of the customer;
a number of recommended connections;
a recency of a profile update; and
a page view metric.

7. The method of claim 5, wherein the one or more marketing engagement features include at least one of:
a click-through rate for marketing emails.

8. The method of claim 5, wherein the one or more account features include at least one of:
a potential spending; and
a metric representing a quality of the customer as a sales lead.

9. The method of claim 1, wherein the output comprises a marketing email for the educational technology product.

10. The method of claim 1, wherein acquiring the customer for the educational technology product comprises activating a free trial of the educational technology product.

11. An apparatus, comprising:
one or more processors; and
memory storing instructions that, when executed by the one or more processors, cause the apparatus to:
obtain a set of features associated with a customer, wherein the set of features comprises profile data from an online professional network;
use a statistical model and the features to predict a likelihood of acquiring the customer for an educational technology product; and
use the likelihood to generate output for use in targeting the customer with the educational technology product.

12. The apparatus of claim 11, wherein the memory further stores instructions that, when executed by the one or more processors, cause the apparatus to:
obtain a market segment for the customer; and
modify the output based on the market segment.

13. The apparatus of claim 12, wherein modifying the output based on the market segment comprises:
applying a threshold for the market segment to the likelihood prior to generating the output.

14. The apparatus of claim 12, wherein modifying the output based on the market segment comprises:
tailoring the output to the market segment.

15. The apparatus of claim 11, wherein the set of features comprises:
one or more network engagement features;
one or more marketing engagement features; and
one or more account features.

16. The apparatus of claim 15, wherein the one or more network engagement features include at least one of:
a measure of engagement with content in the online professional network;
a measure of engagement with electronic communications from the online professional network;
a number of premium subscribers in a second-degree network of the customer;
a number of recommended connections;
a recency of a profile update; and
a page view metric.

17. The apparatus of claim 15, wherein the one or more marketing engagement features include at least one of:
a click-through rate for marketing emails.

18. The apparatus of claim 15, wherein the one or more account features include at least one of:
a potential spending; and
a metric representing a quality of the customer as a sales lead.

19. A system, comprising:
an analysis module comprising a non-transitory computer-readable medium storing instructions that, when executed, cause the system to:
obtain a set of features associated with a customer, wherein the set of features comprises profile data from an online professional network; and
use a statistical model and the features to predict a likelihood of acquiring the customer for an educational technology product; and
a management module comprising a non-transitory computer-readable medium storing instructions that, when executed, cause the system to use the likelihood to generate output for use in targeting the customer with the educational technology product.

20. The system of claim 19, wherein the non-transitory computer-readable medium of the analysis apparatus further stores instructions that, when executed, cause the system to:
obtain a market segment for the customer; and
modify the output based on the market segment.
